(19) United States
(12) Patent Application Publication
(10) Pub. No.: US 2026/0211080 A1
(43) Pub. Date: Jul. 23, 2026

(54) FALSE TARGET FILTERING

(71) Applicant: Zadar Labs Inc., Campbell, CA (US)

(72) Inventors: Mohammad EMADI, Monte Sereno, CA (US); Ali MOSTAJERAN, Morgan Hill, CA (US)

(73) Assignee: Zadar Labs Inc., Campbell, CA (US)

(21) Appl. No.: 19/568,700

(22) Filed: Mar. 16, 2026

Related U.S. Application Data
(63) Continuation of application No. 18/307,581, filed on Apr. 26, 2023.
(60) Provisional application No. 63/363,750, filed on Apr. 28, 2022.

(51) Int. Cl. G01S 7/41; G01S 13/50

(52) U.S. Cl. CPC G01S 7/415; G01S 13/505

(57) ABSTRACT

Disclosed herein are systems and methods for filtering false targets from radar scans. A point in a current scan frame is associated with a doppler and point range from the radar. The point is validated and its doppler, point range, and scan time are used to determine an expected range of the point in a subsequent scan frame. A matching point is found within the expected range. The matching point is analyzed and validated over multiple consequent scans. Each successful detection of the point (e.g., validation of the matching point) in subsequent scan within its corresponding expected range is considered a positive identification. A positive identification count which exceeds a threshold relative to the total number of scans may indicate a valid target. Thus, a positive identification count for a point over multiple scans which is less than the threshold is classified as a false target.

### CROSS-REFERENCE TO RELATED APPLICATIONS

The present application is a continuation of U.S. patent application Ser. No. 18/307,581, filed Apr. 26, 2023, and entitled “FALSE TARGET TRACKING,” which claims the benefit of priority filing date of U.S. Provisional Patent Application No. 63/363,750, filed Apr. 28, 2022, and entitled “FALSE TARGET FILTERING.” Each of the foregoing applications is hereby incorporated by reference in its entirety for all purposes.

### BACKGROUND

### Field of the Art

The present embodiments relate to radar systems. More specifically, the present embodiments relate to systems, apparatus, and methods for removing noise and false targets from radar-produced data.

### Discussion of the State of the Art

In radar processing, radar-produced data requires significant data processing to distinguish between real objects in the environment and noise which may look like a real object. Conventional techniques for removing false targets and noise from radar-produced data typically require significant computational resources and can result in operational complexity. In particular, conventional techniques for removing a false target require a tracking algorithm, which can include, for example, locating a point, looking around the point, maintaining stable tracking of the point over time, implementing Kalman filtering, and so forth. However, the implementation of tracking algorithms invokes a large computational burden on a processing system.

False targets can occur from various sources. For example, false targets may result from aspects of internal hardware of a radar. Radar systems are composed of real components that can exhibit non-linear behavior, imbalances, and other behavior that can negatively impact radar data quality. Particularly, for range-doppler radar data, such behavior can manifest as spurious signals (also referred to as spurs). While spurs have some doppler, they are not valid targets because they generally are not moving and thus remain in the same position. False targets may include random ghost targets, such as reflections of an actual target. Conventional tracking algorithms and less sophisticated tracking algorithms may fail to reject ghost targets from detection.

False targets can also arise from environmental factors, including motions of a non-rigid object, where the global motion of the object consists of several local micro-motions. This results in frequency modulation of the reflected radar signal. For example, human locomotion can involve different body parts moving, or an automobile can include wheels moving at different velocities from the body of the vehicle. Conventional techniques for target classification and target recognition of non-rigid objects can inaccurately detect and classify the components of the non-rigid object as distinct targets separate from the non-rigid object as a whole.

Another environmental factor may include interference. Interference occurs when unwanted radio frequency energy enters the radar circuits. For example, a jammer may occur, where the presence of another radar in the environment may illuminate signals to the original radar and thereby masks targets of interest. At some specific range, many points exhibiting doppler will be observed, but none of the points exhibit movement. Yet another environmental factor may include multipath. The phenomenon of multipath may also give rise to false targets. Multipath results in a signal reaching a radar by two or more paths, due to, for example, atmospheric ducting, refraction, reflection, and so forth. Conventional techniques for target classification may fail to recognize points arising from interference or multipath as false targets.

Accordingly, improved techniques for radar target recognition and classification are desired.

### SUMMARY

Systems and methods in accordance with various embodiments of the present disclosure may overcome one or more of the aforementioned and other deficiencies experienced in conventional approaches to radar signal processing and target recognition. In particular, various embodiments describe approaches to identifying and filtering false targets in radar systems.

In certain embodiments, the invention may determine whether a particular point in a radar scan is a valid target or false target based on analysis of multiple radar scans. A radar scan will typically include noise or other false targets in the radar output. Points (e.g., targets) within a radar scan may be associated with a doppler value at a particular time in the scan frame. For example, a point in a current scan frame may have a doppler value of 10 m/s. The point's range (e.g., distance from the radar) is expected to change in the next frame due to its velocity relative to the radar sensor. The point's Doppler is validated in the current scan frame, and an expected range of the point in the next scan frame is calculated based on the point range, the Doppler value, and the time duration between the scans. This expected range is used to find a potential matching point (also referred to as a found point) within that range.

The matching point is analyzed and validated over multiple consequent scans. Each successful detection of the point (e.g., validation of the matching point) in subsequent scans within its corresponding expected range can be considered a positive identification. A positive identification count which exceeds a threshold may indicate a valid target. If the positive identification count for a point over multiple scans exceeds a threshold, the point is considered a valid target. On the other hand, if the positive identification count is less than the threshold, the point is determined to be a false target.

In certain embodiments, approaches identify a potential target within the radar data based on one or more predetermined characteristics, such as signal strength associated with the potential target, size of the potential target, or shape of the potential target. Approaches can validate the point by comparing the Doppler frequency shift of the point to a predetermined Doppler frequency shift threshold and comparing the change in range of the point to a predetermined range change threshold. The point is considered valid when the Doppler frequency shift and the change in range satisfy their respective predetermined thresholds.

In other embodiments, approaches can determine the expected range of the point in the second radar scan by calculating a predicted range of the point based on the Doppler frequency shift associated with the point, the time period between the first and the second radar scans, and the range of the point in the first radar scan. The system may update the predicted range based on identified factors that impact the precision of range measurements obtained and identify a search area within the second radar scan, centered around the updated predicted range, to locate the matching point. Additionally, the radar system may validate a position of the matching point by matching coordinates of the point with coordinates of the matching point.

In various embodiments, the radar system may classify a special case as a valid target, wherein the special case includes a point that would otherwise be identified as a false target.

Embodiments of the present invention offer a variety of advantages. One advantage of the invention is the ability to eliminate false targets resulting from various sources, such as non-rigid objects, interference, multipath, and others. By effectively identifying and filtering false targets, the radar system can enhance the overall performance of radar-based applications, such as target tracking, collision avoidance, and autonomous navigation systems. For example, the present invention can recognize that although many points appear at a specific range and exhibit a Doppler shift, none of these points exhibit movement. Thus, the present invention can identify such points as false targets and eliminate them.

Another advantage of the present invention is the reduction of computational complexity in identifying false targets. Conventional techniques for radar target recognition and classification utilize tracking algorithms, which require large memory and processing resources. With imaging radar, the maximum number of targets that current solutions in the market can track is roughly between 30 to 120 targets. However, the number of real false target points that can be present at any moment can be as high as 1000 to 10,000. By eliminating false targets (e.g., arising from interference, non-rigid objects, multipath, spurs, random ghost targets, etc.) more efficiently, the number of points to track is significantly reduced, resulting in substantial power savings and improved real-time performance.

A further advantage of the present invention is the flexibility and adaptability it offers. The radar system can be configured to handle a diverse set of conditions, and the special case filter can be customized to address specific requirements of the radar system's application. This adaptability enables the radar system to maintain optimal performance even in challenging and dynamic environments, ensuring accurate target identification and filtering across various scenarios and operating conditions.

Yet another advantage of the present invention is its potential to improve the overall reliability of radar systems. By accurately identifying and filtering false targets, the radar system can avoid erroneous decisions and actions based on false target information. This improved reliability can enhance the safety and effectiveness of radar-based applications, particularly in scenarios where accurate target identification and filtering are crucial for decision-making and system performance.

Various other advantages and benefits are provided by the present invention, as described and suggested in the embodiments disclosed herein. These advantages contribute to the overall effectiveness, efficiency, and performance of radar systems, enabling improved target identification and filtering across a wide range of applications and environments.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an example environment in which aspects of the various embodiments can be implemented.

FIG. 2 illustrates an example of a false target filtering system in accordance with an exemplary embodiment.

FIG. 3 illustrates an example process for identifying and filtering false targets in radar systems in accordance with various embodiments.

FIG. 4 illustrates an example process for identifying and filtering false targets in radar systems in accordance with an alternate embodiment.

FIG. 5 illustrates components of a computing device that supports an embodiment of the present invention.

FIG. 6 illustrates an exemplary architecture of a system that supports an embodiment of the present invention.

FIG. 7 illustrates another exemplary architecture of a system that supports an embodiment of the present invention.

FIG. 8 illustrates components of a computer system that supports an embodiment of the present invention.

### DETAILED DESCRIPTION

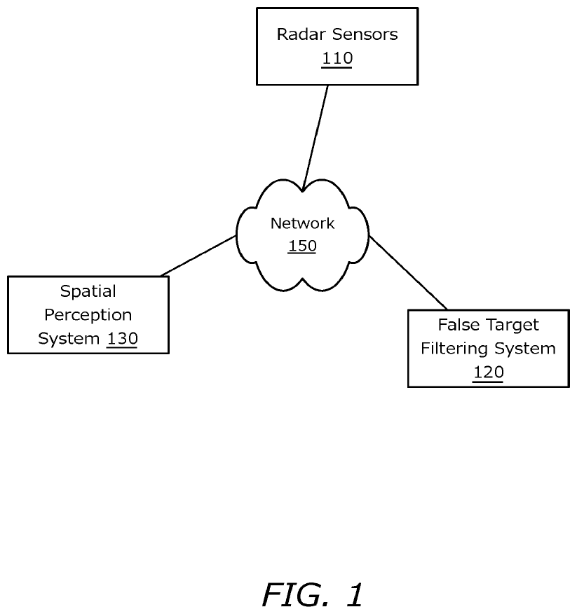

The approaches described herein relate to systems and methods for filtering false targets from radar scans through a process of point validation and analysis over multiple consequent scans. These approaches associate each point in a current scan frame with a doppler and point range from the radar, validating the point and determining its expected range in subsequent scan frames. To provide a better understanding of the approaches and their various embodiments, FIG. 1 illustrates an example environment in which aspects of the various embodiments can be implemented. It should be understood that reference numbers are carried over between figures for similar components for purposes of simplicity of explanation, but such usage should not be construed as a limitation on the various embodiments unless otherwise stated. As shown, the environment may comprise radar sensors 110, false target filtering system 120, and spatial perception system 130. It should be known that the various systems and components described herein are exemplary and for illustration purposes only. Radar sensors 110, false target filtering system 120, spatial perception system 130, and network 150 may be on a single system. In another embodiment, they may be on a distributed system. The components may be reorganized or consolidated, as understood by a person of ordinary skill in the art, to perform the same tasks on one or more other servers or devices without departing from the scope of the invention. Other components may be used, as would be readily understood by a person of ordinary skill in the art, without departing from the scope of the embodiments described herein.

Radar sensors 110 can collect signal data of objects in an environment. Radar sensors 110 may comprise radar systems known in the art for receiving radar signals. In a specific example, radar systems comprise electronic devices designed to emit electromagnetic waves and analyze the signals that return after interacting with objects in the surrounding environment.

Radar sensors 110 may be used in automotive radar systems, where receiver antennas associated with automated driving systems may collect signal data of objects in the vehicle's environment, such as other vehicles, pedestrians, and road signs. These radar sensors 110 may be designed to operate at various frequencies and may use different techniques to analyze the returned signals. Other examples of radar sensors 110 may include weather radar systems used by meteorologists to detect precipitation and other weather phenomena, or military radar systems used for surveillance, reconnaissance, and target tracking.

The output of the radar sensors 110 is typically raw radar-produced data, which may include a large amount of noise and false targets that are not relevant to the intended target or objects of interest. The radar-produced data may include various types of information about the detected objects, such as their distance, speed, direction of movement, size, shape, and radar cross-section. In some embodiments, the radar-produced data may include points (e.g., targets).

In an embodiment, a point can refer to a specific location in the radar data that corresponds to a detected object or target. A point is typically represented by a set of coordinates that describe its location in the radar scan frame, as well as other information such as its radar cross-section, doppler value, and range from the radar sensor.

In an embodiment, a scan frame can refer to a specific moment in time when a radar sensor collects and processes a set of radar data. A scan frame typically includes a sequence of measurements of the radar signals that are transmitted and received by the radar sensor during a particular time interval. The duration of a scan frame can vary depending on the specific radar system and the application, but it is typically a few microseconds to several milliseconds long. The duration of a scan frame is determined by the range resolution of the radar system, which is the minimum distance that can be resolved by the radar based on the duration of the transmitted signal. During a scan frame, the radar sensor emits a series of electromagnetic waves and analyzes the signals that are reflected or scattered back from objects in the surrounding environment. The radar data collected during a scan frame typically includes information about the distance, velocity, and other properties of the detected objects, as well as noise and false targets. The radar-produced data obtained from a scan frame is typically processed and analyzed by signal processing algorithms and techniques to remove the noise and false targets and extract meaningful information about the detected objects and the environment. The processing of radar data may involve various techniques such as filtering, clustering, tracking, and classification to improve the accuracy and reliability of the radar system.

The doppler value associated with a point is a measure of the change in frequency of the transmitted radar signal caused by the motion of the target relative to the radar sensor. This information can be used to determine the speed and direction of the detected object. The range from the radar sensor can be determined by measuring the time it takes for the transmitted radar signal to travel to the object and back to the radar sensor.

A point in the radar-produced data may be a valid target or a false target. Valid targets are objects that are of interest and relevant to the purpose of the radar system, while false targets are typically caused by noise, interference, or other factors and may need to be filtered out from the data.

In some embodiments, the radar-produced data may include multiple points that correspond to the same object or target, but at different times or from different perspectives. By analyzing the patterns and characteristics of these points over time, it may be possible to obtain a more accurate and detailed understanding of the object or target, such as its size, shape, and movement pattern.

The radar-produced data may also include information about the environment, such as weather conditions or other sources of interference. The radar-produced data may be in the form of digital signals or other electronic data formats.

In an embodiment, this raw data can be processed by false target filtering system 120, which utilizes various techniques and algorithms to identify and filter out false targets from the radar data, as described further herein.

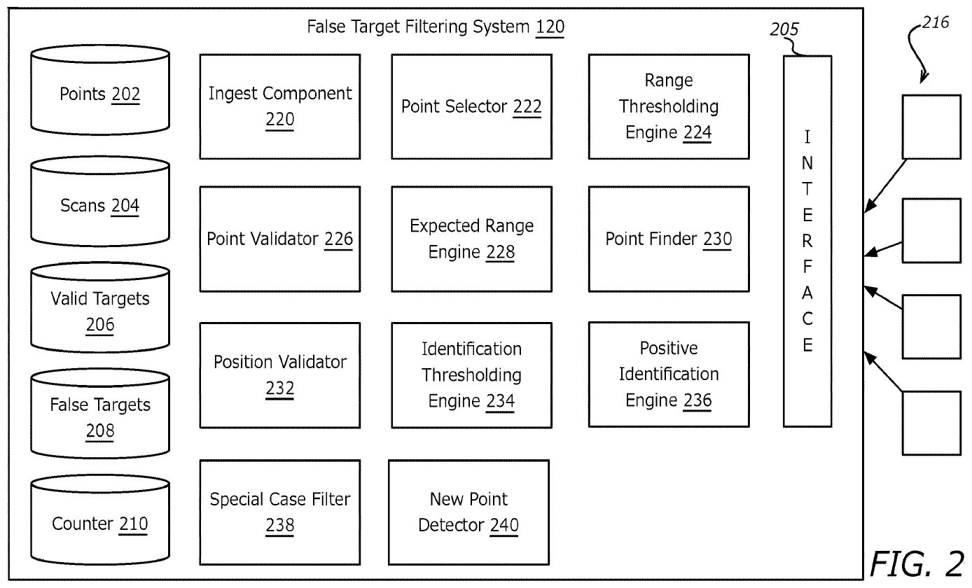

False target filtering system 120 is described in greater detail in FIG. 2 below, but in general, false target filtering system 120 is operable to identify and filter out false targets from radar-produced data obtained from radar sensors 110 or other obtained radar-produced data. In accordance with various embodiment, false target filtering system 120 utilizes various techniques and algorithms to analyze the radar-produced data and distinguish valid targets from noise and false targets.

False target filtering system 120 may include one or more processing devices, such as a computing device or a digital signal processor, and a memory device that stores instructions for executing the false target filtering algorithms. The false target filtering system 120 may also include various input/output devices for receiving and outputting the radar data.

In an embodiment, false target filtering system 120 may identify valid targets for further processing by spatial perception system 130. False targets may result from aspects of internal hardware of a radar system, such as spurious signals (also referred to as spurs) or random ghost targets. False targets may also arise from interference (e.g., jamming, etc.), different velocities from multiple moving components of non-rigid objects (e.g., locomotion of limbs and body of human movement, wheels of a vehicle moving at different velocities than the body of the vehicle, etc.), multipath, and so forth. A radar scan will typically include points associated with false targets. Points within a radar scan may be associated with a doppler value and a range (from the radar) at a particular time in the scan frame. A valid target will be associated with a doppler value and a change in range (e.g., exhibit movement) from one scan frame to the next. In contrast, a false target may or may not be associated with a doppler, but it will typically not exhibit a change in range (e.g., a false target, despite exhibiting doppler, will not be moving positions between scan frames). For example, a point in a current (e.g., first) scan frame may be associated with a doppler value (and therefore has a radial velocity relative to a radar) and a first range from a radar. In a next scan frame, the point may be associated with a second range from the radar, because it is associated with a velocity relative to the radar and therefore has a change in range (e.g., the point has moved between scan frames).

In certain embodiments, the point's doppler is validated in the current scan frame. For example, the point may be determined to be a valid target based on the point's doppler, change in range, and time of scan. When the relation between the change in range, the point's associated doppler, and the scan time falls below a predetermined range threshold, the point is determined to be a valid target.

In an embodiment, determining the expected range of a point comprises identifying the range from the radar which the point is expected to have in a subsequent (e.g., second) scan frame. In an example, the expected range may be calculated based on the point range of the validated point (e.g., the first range of the point in the first scan frame), the doppler associated with the point, and the scan time. In another example, determining the expected range of a point comprises calculating the expected range based on the Doppler frequency shift associated with the point, the time period between the first and second radar scans, and the range of the point in the first radar scan. For example, if a point in the first radar scan has a Doppler frequency shift of 20 Hz, a range of 100 meters, and the time period between the two scans is 0.1 seconds, the expected range can be calculated using these parameters. A person skilled in the relevant field can apply a suitable mathematical model or equation that incorporates the Doppler frequency shift, range, and time period to estimate the expected range of the point in the second radar scan. In an embodiment, the expected range can be updated based on identified factors that impact the precision of range measurements obtained, such as environmental conditions, hardware limitations, or other sources of error. For instance, if it is determined that atmospheric conditions cause a 2% error in range measurements, the expected range can be adjusted accordingly to account for this error. Once the expected range is updated, a search area within the second radar scan is identified, centered around the updated expected range, to locate the matching point.

The expected range is used to find a matching point (also referred to as a found point) within and/or closest to the expected range. The matching point is analyzed and validated over multiple consequent scans. Each successful detection of the point (e.g., validation of the matching point) in subsequent scans within its corresponding expected range can be considered a positive identification. A positive identification count which exceeds a predetermined positive identification threshold may indicate a valid target. Thus, a positive identification count for a point over multiple scans which is less than the positive identification threshold may be determined to be a false target.

Spatial perception system 130 may comprise systems which can utilize the detected valid targets in radar signal processing. In an embodiment, spatial perception system 130 may include autonomous vehicle perception systems or other driver assistance systems. In other embodiments, spatial perception system 130 can include other beamforming modules, systems which utilize angle of arrival estimation, among others. For example, a beamforming module can select points from the valid targets and process them in a round robin fashion.

Network 150 may facilitate communication between the radar sensors 110, false target filtering system 120, and spatial perception system 130. In an embodiment, false target filtering system 120 can be within a network (e.g., in communication with or associated with network 150). In another embodiment, false target filtering system 120 can be on the network edge (e.g., contained inside a single radar sensor which is in communication with network 150). Network 150 can be an internal network or on-premises network, the Internet, etc., which allows radar sensors, the false target filtering system 120, and spatial perception system 130 to communicate on the premise (e.g., locally, for example, on an autonomous vehicle). In another example, communication between the components may be facilitated remotely (e.g., relayed to a cloud network). Network 150 may include on-premise databases. The on-premise databases may communicate with each other to collect, sort, store, and/or analyze radar data. In another embodiment, network 150 may include an internal data bus (e.g., a bus between a processor and a memory system).

The system may be reorganized or consolidated, as understood by a person of ordinary skill in the art, to perform the same tasks on one or more other servers or computing devices without departing from the scope of the invention.

FIG. 2 illustrates an example of a false target filtering system 120 in accordance with an exemplary embodiment. As described, false target filtering system 120 identifies and filters out false targets from radar-produced data obtained from radar sensors 110. False target filtering system utilizes various algorithms to distinguish valid targets from noise and false targets caused by hardware, interference, non-rigid object movements, multipath, and more. A valid target will exhibit a change in range from one scan frame to the next, while a false target will not. False target filtering system 120 validates the point's doppler and calculates the expected range for a matching point in the subsequent scan frame. A positive identification count over multiple scans exceeding a predetermined threshold indicates a valid target, while less than the threshold indicates a false target. False target filtering system 120 may identify valid targets for further processing by spatial perception system 130.

It should be understood that reference numbers are carried over between figures for similar components for purposes of simplicity of explanation, but such usage should not be construed as a limitation on the various embodiments unless otherwise stated. It should be further known that the various components described herein are exemplary and for illustration purposes only. In this example, the false target filtering system 120 may comprise interface 205, input sources 216, ingest component 220, point selector 222, range thresholding engine 224, point validator 226, expected range engine 228, point finder 230, position validator 232, identification thresholding engine 234, positive identification engine 236, special case filter, and new point detector 240. False target filtering system 120 may also include or be in communication with one or more data stores, including, for example, points data store 202, scans data store 204, valid targets data store 206, false targets data store 208, and counter data store 210.

It should be noted that although the data stores are shown as separate data stores, data from the data stores can be maintained across fewer or additional data stores. The data stores can be accessed by each of the various components in order to perform the functionality of the corresponding component. Other components, systems, services, etc. may access the data stores. Although false target filtering system 120 is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein.

Points (e.g., targets) detected by radar sensors in an environment can be stored in the points data store 202. In an embodiment, targets detected by radar systems can include various types of objects, such as aircraft, vehicles, ships, and pedestrians, among others. Points data store 202 can store information about the detected targets, including their position, velocity, size, and other properties. In certain embodiments, points data store 202 may store additional information about the detected points, such as the confidence level of the detection and any classification or identification information. The environments in which radar systems are used can vary depending on the application. For example, radar systems can be used in aviation for air traffic control, weather monitoring, and collision avoidance systems. In the automotive industry, radar sensors can be used for adaptive cruise control, collision warning systems, and blind-spot detection systems. In military applications, radar systems can be used for surveillance, tracking, and targeting. Other environments where radar systems may be used include marine navigation, meteorology, and space exploration, among others.

The radar-produced data obtained from the radar sensors or other types of radar systems can be stored in scan data store 204. In an embodiment, scan data store 204 stores a sequence of radar scan frames, each of which includes a set of measurements of the radar signals collected during a specific time interval. In certain embodiments, scan data store 204 may also include information about the radar system settings, such as the radar frequency, bandwidth, and pulse repetition interval. In an embodiment, the radar scans are performed periodically at predetermined time intervals to produce a sequence of temporally equidistant scan frames. Each scan frame is associated with a scan time or frame time, which is the time when the radar data is collected. The points detected in each scan frame are stored in the points data store 202, and the sequence of scan frames is stored in the scan data store 204.

Points which are validated (e.g., detected and recognized as a valid target) can be stored in valid targets data store 206. In an embodiment, valid targets data store 206 may be utilized by spatial perception system 130 for further processing. For example, the spatial perception system 130 may use the information about the validated targets to build a 3D model of the environment or to generate a map of the objects in the vicinity.

Points which are identified as false targets are stored in false targets data store 208. In an embodiment, false targets are eliminated (e.g., removed) from a list of detected targets utilized by spatial perception system 130. False targets are typically eliminated by excluding them from the valid targets data store 206 or by flagging them as false targets in the data store. In certain embodiments, the false target filtering system 120 may count the number of positive identifications of a particular point (e.g., identification of the point as a valid target) over a plurality of consequent scans. Such counts can be stored in the counter data store 210, which can be used to determine whether a point is a valid or false target based on the number of positive identifications exceeding a predetermined threshold.

Ingest component 220 is operable to receive through interface 205 a selection of input sources 216 for radar-produced data. In various embodiments, interface 205 may include a data interface and service interface may be configured to periodically receive data sets, requests, and/or any other relevant information comprising or relating to radar-produced data, for example, points (e.g., targets) in an environment collected from imaging radar sensors or radar antenna. Interface 205 can include any appropriate components known or used to receive requests or other data from across a network, such as may include one or more application programming interfaces (APIs) or other such interfaces for receiving such requests and/or data. The input sources 216 can include, for example, various radar data sources. Examples of radar data sources may include portable radar systems, radar antennas, configuration files comprising radar data, and so forth. In certain embodiments, radar data sources 216 may include a plurality of periodic radar scans of a particular environment.

Range thresholding engine 224 is operable to determine a validation threshold value for validating a point. Validating a point, in accordance with various embodiments, comprises determining whether the point is a valid target or a false target. The validation threshold can be a predetermined value, calculated based on certain criteria or may be a range or set of ranges.

Range threshold ε is a value that may be calculated for a point, and the range threshold ε is compared against the validation threshold to determine whether the point is a valid or false target. In an embodiment, the range threshold ε will be a smaller value for valid targets, whereas the value will be larger for false targets and noise. In another embodiment, a point having a range threshold ε less than the validation threshold may indicate a valid target, whereas a point having a range threshold ε exceeding the validation threshold may indicate a false target. In another embodiment, the validation threshold may be a range or set of ranges. Thus, points whose range threshold ε falls within a particular validation range may be determined to be valid targets, whereas points whose range threshold ε falls within another validation range may be determined to be false targets.

Point selector 222 is operable to select a point (e.g., p) from a radar scan. In an embodiment, the point may be selected randomly. In another embodiment, the point may be selected from a particular azimuth, range, elevation, or doppler relative to the radar, or from a particular order thereof as set in a preconfigured file, etc. The point in a first scan (e.g., first scan frame) may be associated with a first point range (e.g., range from the radar) and a doppler. In the embodiment, the doppler can be the radial velocity of the point toward (or from) the radar. The first point range is the range of the point from the radar, which can be directly provided by the radar, measured from the point coordinates, etc. The point in a second scan (e.g., second scan frame) may be associated with a second point range. Real world objects generally do not instantly change their speed significantly. Therefore, during a time that is small enough between scans, the point's range will be changed by some value r_{Δ}. The change in point range can be represented by formula (1):

$${r}_{Δ} = d * t \qquad ( 1 )$$

where r_{Δ} is the point range change during a time duration t (e.g., time between the first and second scans), and d is the point doppler (e.g., radial velocity of the point relative to the radar).

In an embodiment, the time duration can be further represented by formula (2):

$${r}_{Δ} = d * {t}_{scan} \qquad ( 2 )$$

where the change in point range (e.g., range difference r_{Δ}) for the selected point p is calculated between two consequent radar scans Sₚᵣₑᵥᵢₒᵤₛ (e.g., first scan) and S_{current} (e.g., second scan). The range difference r_{Δ} may be determined by the difference between radar reported ranges of the point from the first scan (e.g., previous point range) and the second scan (e.g., current point range). This can be represented by formula (3):

$${r}_{current} - {r}_{previous} = d * {t}_{scan} \qquad ( 3 )$$

In certain embodiments, for points that represent a valid target, the range difference (e.g., r_{current}−rₚᵣₑᵥᵢₒᵤₛ) will be equal to its doppler multiplied by the time between radar scans. Accordingly, the values will not be equal when the point is a false target. The range threshold ε can be used to distinguish between a valid or false target, based on the difference between such values (e.g., between the range difference and the doppler multiplied by the scan time). In another embodiment, a range threshold ε can be determined based on the range difference of the point between scans in relation to its associated doppler and the time duration between the scans. The range threshold for validating a point can be represented by formula (4):

$$ε = \vert d * {t}_{scan} - {r}_{current} + {r}_{previous} \vert \qquad ( 4 )$$

Moreover, measuring the range threshold ε allows for consideration of radar system resolution and the elimination of rounding errors.

Point validator 226 is operable to validate the selected point, for example, determine whether the point is a valid target. In an embodiment, point validator 226 may utilize formula (4) to determine its range threshold ε by evaluating the relationship between the point's change in range between two consequent scan frames, the doppler associated with the point, and the time duration between the scan frames. If the point's range threshold ε is large (e.g., above the validation threshold), then the point is determined to be a false target. If the point's range threshold ε is small (e.g., below the validation threshold), then the point is determined to be a valid target. In another embodiment, if the point's range threshold ε falls within a predetermined validation range, the point is a valid target. If the point's range threshold ε falls outside of the validation range (or falls within a predetermined invalidation range), the point is a false target.

Expected range engine 228 is operable to determine the point range from the radar within which the point is expected to be located in a subsequent scan frame. The point's expected range can be calculated based on formula (5):

$${r}_{expected} = {r}_{previous} + d * {t}_{scan} \qquad ( 5 )$$

where r_{expected} is the validated point's expected range for the current scan, rₚᵣₑᵥᵢₒᵤₛ is the point's radar-reported range for the previous scan, d is the doppler associated with the point, and t is the time duration between the previous scan and current scan. Once the expected range for the selected point is calculated for the current scan, point finder 230 is configurable to find a matching point (e.g., potential matching point or found point) in the current scan that appears within the expected range or close to the expected range.

Positive identification engine 236 is operable to validate the matching point by, for example, determining whether the matching point matches the validated point (e.g., selected point in the previous scan). A positive identification occurs when a matching point is determined to belong to a valid target. Positive identification engine 236 also determines how closely the doppler associated with the matching point matches the doppler associated with the validated point. If the matching point's doppler deviates from the doppler of the validated point by a predetermined range, positive identification engine 236 disregards the matching point and searches for the next closest matching point.

In certain embodiments, positive identification engine 236 may determine whether the matching point is a valid target (e.g., validate the matching point) by utilizing formula (6):

$$ε = \vert d * {t}_{scan} - {r}_{found} + {r}_{previous} \vert \qquad ( 6 )$$

where ε is the range threshold; r_{found} is the radar-reported range of the found matching point in the current scan S_{current}; rₚᵣₑᵥᵢₒᵤₛ is the radar-reported range of the validated point in the previous scan Sₚᵣₑᵥᵢₒᵤₛ; d is the point doppler associated with the validated point; and t_{scan} is the scan time. In an embodiment, a smaller value for the range threshold ε can indicate a valid target, whereas a larger value would indicate a false target or noise. In other embodiments, a range threshold ε which falls within a specific range and or is below a predetermined validation threshold value can indicate a valid target. Each validation of a matching point can be considered a single positive identification. Positive identification engine 236 can continue to validate matching points in subsequent scans, resulting in a plurality of positive identifications for the selected point in multiple scans (e.g., N scans).

In an embodiment, the range threshold can be compared to a predetermined validity criterion to determine the point's validity as a target. When the range threshold satisfies the predetermined validity criterion, the point is determined to be a valid target. Conversely, if the range threshold does not satisfy the predetermined validity criterion, the point is discarded as a false target. In an embodiment, the predetermined validity criterion can include at least one of a maximum allowable range difference, a minimum required Doppler frequency shift, or a combination of range and Doppler frequency shift constraints.

In an example illustrating the use of the maximum allowable range difference as a predetermined validity criterion, consider a radar system with a maximum allowable range difference of 10 meters. In this example, a point P1 (100) in the first radar scan has a range of 500 meters. A matching point P2 (102) is found in the second radar scan within the expected range. The range difference between P1 (100) and P2 (102) is calculated to be 8 meters, which is less than the maximum allowable range difference of 10 meters. In this case, the point is considered a valid target, as it satisfies the maximum allowable range difference criterion.

In another example illustrating the use of the minimum required Doppler frequency shift as a predetermined validity criterion consider a radar system with a minimum required Doppler frequency shift of 2 Hz. In this example, a point P1 (200) in the first radar scan has a Doppler frequency shift of 2.5 Hz. The matching point P2 (202) in the second radar scan has a Doppler frequency shift of 2.3 Hz. The difference between the Doppler frequency shifts of P1 (200) and P2 (202) is 0.2 Hz, which is less than the minimum required Doppler frequency shift of 2 Hz. In this case, the point is considered a valid target, as it satisfies the minimum required Doppler frequency shift criterion.

In yet another example illustrating the use of a combination of range and Doppler frequency shift constraints as a predetermined validity criterion, consider a radar system with a maximum allowable range difference of 10 meters and a minimum required Doppler frequency shift of 2 Hz. In this example, a point P1 (300) in the first radar scan has a range of 500 meters and a Doppler frequency shift of 3 Hz. A matching point P2 (302) is found in the second radar scan within the expected range. The range difference between P1 (300) and P2 (302) is 9 meters, and the Doppler frequency shift difference is 0.8 Hz. In this case, the point is considered a valid target, as it satisfies both the maximum allowable range difference and the minimum required Doppler frequency shift constraints.

Identification thresholding engine 234 is operable to set a parameterized threshold for the minimum of positive identifications (e.g., M) required from a plurality of scans (e.g., N) for the selected point (and its corresponding matching points in the scans) to be considered a valid target. In an embodiment, positive identification engine 236 can determine whether a selected point and its corresponding matching point are valid from two consequent scans. In another embodiment, positive identification engine 236 can validate corresponding matching points from N multiple scans and track the number (e.g., count, C) of positive identifications. The count (e.g., C) of positive identifications may increase as more subsequent matching points are validated (e.g., matched to) its corresponding point (e.g., validated point from the previous scan). In an embodiment, after points from N scans are evaluated, the positive identification count C is compared to the parameterized threshold M. A positive identification count which is below the parameterized threshold can indicate a false target (e.g., C<M). In contrast, a positive identification count which is equal to or above the parameterized threshold may be considered a valid target.

Position validator 232 is operable to evaluate how close in position the matching point is to that of the validated point. By evaluating the closeness of point position, position validator 232 can guard against false positives from evaluating the closeness of points based solely on matching doppler and expected range. For example, a potential matching point may share the same or substantially similar doppler and range as the validated point, but may be located in a different position in the environment. Thus, position validator 232 can validate the coordinates of the matching point by utilizing formula (7) to measure the distance between matching point and the validated point:

$$distance = \sqrt{{( {x}_{2} - {x}_{1} )}^{2} + {( {y}_{2} - {y}_{1} )}^{2} + {( {z}_{2} - {z}_{1} )}^{2}} \qquad ( 7 )$$

where x₁, y₁, z₁ are the coordinates of the validated point (e.g., point in the previous scan) and x₂, y₂, z₂ are the coordinates of the validated point.

Special case filter 238 is operable to recognize cases that should be considered valid targets which would otherwise be immediately recognized as false targets, and vice versa. The special case filter 238 can be incorporated into the radar system to handle exceptions, allowing for more accurate target identification and filtering under specific conditions.

In certain embodiments, the special case filter 238 is configured to analyze the radar data and consider the context of the environment in which the radar system is operating. For example, when the radar system is deployed in a highly dynamic environment with rapidly changing conditions, such as an urban setting, the special case filter 238 may recognize points that exhibit unusual behavior or characteristics that would typically be classified as false targets but are, in fact, valid targets under the given circumstances.

In some embodiments, the special case filter 238 may be based on predetermined criteria, such as a set of rules or thresholds, that are established to identify and classify special cases. These criteria can be determined based on various factors, including the type of radar system, the operating environment, and the specific application of the radar system.

Referring to FIG. 2, the special case filter 238 can be implemented within the false target filtering system 120, where it works in conjunction with other components, such as the Doppler frequency shift validator 232. The special case filter 238 can be configured to receive input from these components, as well as other sources of information, to determine whether a point should be classified as a special case.

In one example, a pedestrian's limbs may move at different velocities from the pedestrian's body as a result of natural human locomotion. The false target filtering system 120 may immediately classify the limbs as false targets and the body as a single valid target. However, in certain circumstances, it may be desirable to classify the limbs as valid targets. The special case filter 238 can be configured to identify such exceptional cases where particular targets should be classified as valid or false for a specific radar system.

The special case filter 238 may be user-configurable, allowing for the customization of the filter based on the specific needs and requirements of the radar system's application. This configurability enables the radar system to be more adaptable and versatile, ensuring accurate target identification and filtering across a wide range of scenarios and operating conditions.

New point detector 240 is operable to detect new points which should be classified as valid targets. The probability of a false alarm (e.g., false target identification) is high for a new point which is detected for the first time in a current scan S_{current} because the new point would fail the validation formula (e.g., the point does not have a corresponding previous point in a previous scan). However, new point detector 240 can detect a new point which does not have a predecessor point (e.g., a previously validated point) and evaluate corresponding matching points to the new point in subsequent scans. If the positive identification count for such matching points meets the parameterized threshold, then the new point is considered a valid target.

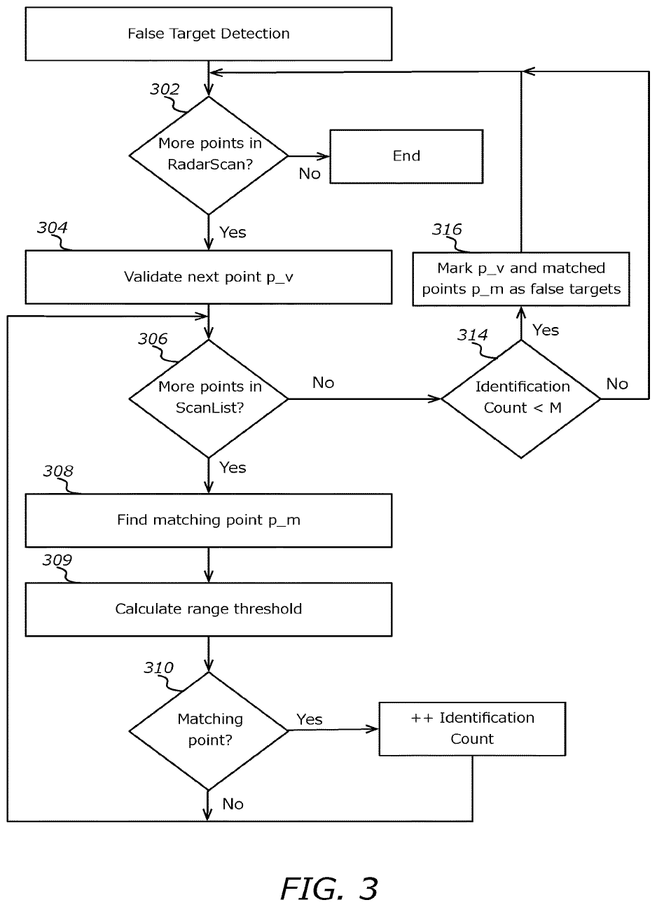

FIG. 3 illustrates an example process for identifying and filtering false targets in radar systems in accordance with various embodiments. In embodiments, the method steps or techniques depicted and described herein can be performed in a processor comprising one or more of false target filtering system 120 as illustrated in FIG. 1, the method steps being encoded as processor-executable instructions in a non-transitory memory of one or more computing devices. The techniques of FIG. 3 and other method steps described herein may be implemented in an operating system kernel, in a separate user process, in a library package bound into network applications, on a specially constructed machine, on an application-specific integrated circuit (ASIC), or a field programmable gate array (FPGA). The process may comprise additional steps, fewer steps, and/or a different order of steps without departing from the scope of the invention as would be apparent to one of ordinary skill in the art.

In this example, radar-produced data is obtained. The radar-produced data can be obtained from radar sensors, which may comprise various types of radar systems known in the art for receiving radar signals. These radar sensors may include portable radars, automotive radar systems, marine radar systems, weather radar systems, and military radar systems, among others.

The radar-produced data from the radar sensors may include noise or other false targets that are not relevant to the intended target or objects of interest. The radar-produced data may include various types of information about the detected objects, such as their distance, speed, direction of movement, size, shape, and radar cross-section. In some embodiments, the radar-produced data may include points (e.g., targets) that are associated with a doppler value at a particular time in the scan frame.

In an embodiment, the process determines 302 whether there are remaining points in the environment to analyze. The number of points and/or order of points to scan in the environment may be predetermined by, for example, a configuration file which identifies which locations in the environment (e.g., three-dimensional coordinates) and/or which order of locations to select from. In another embodiment, points may be selected in order by azimuth angle from the radar, elevation angle from the radar, range from the radar, a combination thereof, etc. In yet another embodiment, a configuration file may define the maximum and/or minimum of points to select and analyze. In yet another embodiment, the number of points to select and analyze may be relative to the total number of points present in a particular environment at the time of the radar scans.

The process collects the radar reported range of the selected point and measures a doppler value associated with the selected point. The process continues to validate 304 the next point pᵥ against each scan in the previous scans. The previous scans may be stored in a scan list (e.g., collection of past scans). The positive identification count is initialized to 0, and the time duration is set to the scan time of the initial scan frame. The point is validated by determining the a range threshold based on the change in point range of the point between the previous and current scans and the range difference's relation to the scan time and doppler of the point. In an embodiment, a low value for the range threshold indicates a valid target (e.g., the point is validated), while a high value for the range threshold indicates a false target. In another embodiment, point whose range threshold which is below a validation threshold value may be validated as a valid target.

Once the point in the current scan is validated, the process checks 306 whether more radar scan frames remain. If there are no more scan frames, the process assesses 314 whether the positive identification count meets a parameterized threshold M. For example, if at least M out of N scans included a positive identification (of a validated point), then the point is determined to be valid. Thus, if c positive identifications were determined out of N scans, and if c≥M, then the point is a valid target. Otherwise, if c<M, then the process classifies 316 the point (and its corresponding matching points in subsequent scans) as false targets.

The process calculates an expected range that the point should have in a next scan frame. The expected range is used to find 308 a matching point pₘ A determination is made 310 whether there is a potential matching point. If a potential matching point fails to have a matching or close to matching doppler and/or point range, the potential matching point is invalidated and the process proceeds to examining the next potential matching point until such are matched and therefore validated. In another embodiment, the matching point is validated when its doppler and point range match the doppler and point range of the validated point (e.g., selected point in previous scan) within a predetermined range. When the matching point is found, the range threshold of the matching point is calculated 309 based on the change in point range of the point (e.g., between the validated point range in the previous scan and the matching point in the current scan) and the change's relation to the scan time and doppler of the point. In an embodiment, a low value for the range threshold indicates a valid target (e.g., the point is validated), while a high value for the range threshold indicates a false target. In another embodiment, point whose range threshold which is below a validation threshold value may be validated as a valid target. Each valid target found in each scan will be considered a positive identification count. When the total positive identification count of a set of multiple scans exceeds the parameterized threshold (e.g., M), the point is determined to be a valid target.

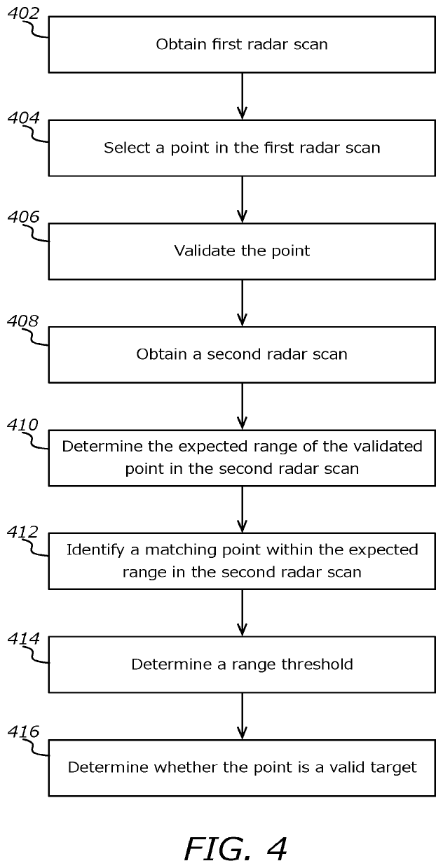

FIG. 4 illustrates an example process for identifying and filtering false targets in radar systems in accordance with an alternate embodiment. The radar system obtains 402 a first radar scan from a radar transmitter and receiver system. The system may use any suitable radar technology, such as pulsed, continuous wave, or frequency-modulated continuous wave radar. The first radar scan captures radar data that represents potential targets within the radar coverage area, including their respective attributes such as distance, speed, direction of movement, size, shape, and radar cross-section.

The radar data from the first scan is processed to identify potential targets represented by points and a point in the first radar scan is selected 404. The selection of a point can be based on predetermined criteria, such as signal strength, signal-to-noise ratio, or a specific range within the radar coverage area. The radar system may employ algorithms, such as clustering or thresholding techniques, to identify and select points that are likely to represent valid targets. For example, raw radar data obtained from the first scan is preprocessed to enhance the signal-to-noise ratio and remove any unwanted artifacts. This may involve applying filtering techniques, such as a moving average filter or a Kalman filter, to reduce noise and improve the quality of the radar data. After preprocessing, the radar data is analyzed to identify potential targets. This can be done using a constant false alarm rate (CFAR) algorithm, which calculates the adaptive detection threshold for each point in the radar data based on the local noise level. Points with signal strength above the adaptive threshold are considered potential targets. The CFAR algorithm can help maintain a consistent false alarm rate even in the presence of varying noise levels across the radar coverage area. The detected potential targets are then grouped into clusters based on their spatial proximity. Clustering techniques, such as the DBSCAN (Density-Based Spatial Clustering of Applications with Noise) algorithm, can be employed to identify groups of points that are likely to belong to the same target. The DBSCAN algorithm groups points that are closely packed together based on a distance metric and a density threshold, effectively distinguishing between points that belong to a target and points that are due to noise or clutter. For each cluster, various features are extracted to represent the potential target. These features may include the centroid of the cluster (which represents the target's estimated position), the size of the cluster (corresponding to the target's radar cross-section), the average Doppler frequency shift of the points within the cluster (indicating the target's relative speed), and other relevant attributes. A representative point is selected for each cluster to be used for further validation and analysis. The selection of a point can be based on specific criteria, such as the point with the highest signal-to-noise ratio within the cluster, the centroid of the cluster, or a weighted combination of different features. This representative point is then used as input for subsequent steps, such as validation and target tracking, in the radar system.

The selected point is validated 406 by analyzing its Doppler frequency shift and change in range. In an example, the Doppler frequency shift can be calculated by comparing the transmitted radar signal frequency with the received signal frequency. The change in range can be determined by monitoring the point's position across consecutive radar scan frames. If the point's Doppler frequency shift and change in range correspond to a plausible target motion, the point is considered valid. Otherwise, it may be flagged as a potential false target. Determining if the point's Doppler frequency shift and change in range correspond to a plausible target motion comprises comparing these values to expected values for genuine targets in the radar system's operating environment. Plausible target motion can be assessed based on one or more of the following factors, including, for example, Doppler frequency shift, change in range, consistency with kinematic constraints, temporal consistency, and the like.

In an embodiment, the Doppler frequency shift is related to the relative speed between the radar and the target. By calculating the Doppler frequency shift, the relative radial velocity of the target can be determined. To assess if the point's Doppler frequency shift corresponds to a plausible target motion, the calculated radial velocity can be compared to the expected velocity range for genuine targets in the environment. For example, in a maritime radar system, the expected radial velocities of ships might be between −30 and 30 knots, while false targets due to clutter or noise might have significantly different velocities.

In an embodiment, the change in range between consecutive radar scans can be analyzed to assess the target's motion in the range dimension. By calculating the range rate (i.e., the change in range per unit time), the target's motion can be compared to the expected range rates for genuine targets. If the range rate falls within the expected bounds for genuine targets, it may indicate a plausible target motion. For instance, in an automotive radar system, the expected range rates for vehicles might be within a specific range, while false targets due to multipath reflections or clutter might exhibit an inconsistent or implausible range rate.

In an embodiment, real-world targets are subject to physical constraints, such as maximum speed, acceleration, and jerk (rate of change of acceleration). By analyzing the point's Doppler frequency shift and change in range, the target's motion can be compared to these kinematic constraints. If the target's motion adheres to these constraints, it may indicate a plausible target motion. For example, an aircraft's motion might be constrained by its maximum speed, turn rate, and rate of climb or descent, while false targets might exhibit erratic or physically impossible motion.

In an embodiment, plausible target motion should exhibit temporal consistency across multiple radar scans. By analyzing the point's Doppler frequency shift and change in range over time, the target's motion can be assessed for consistency with the expected motion of genuine targets. For example, a genuine target's motion might exhibit smooth and predictable changes over time, while false targets due to noise or clutter might show abrupt and unpredictable changes.

A second radar scan is obtained 408. In an embodiment, the second scan may occur after a predefined time interval or triggered by specific conditions, such as changes in the radar environment or the detection of new potential targets.

The expected range of the validated point in the second radar scan frame is determined 410, considering factors like the Doppler frequency shift, the time period between the first and second radar scan frames, and the range of the point in the first radar scan frame. The expected range can be estimated using mathematical models or algorithms that account for target motion, radar system characteristics, and environmental factors. Example models include, constant velocity model, constant acceleration model, Kalman filter, and particle filter. Example environment factors include wind, air density, ocean currents, etc.

A matching point within the expected range in the second radar scan frame is identified 412. In an embodiment, the radar system searches the second radar scan frame for a matching point that corresponds to the validated point from the first scan frame. The matching point can be identified by comparing its Doppler frequency shift and range with the initial point's Doppler frequency shift and range, considering a predetermined tolerance level. The tolerance level may be adjustable based on factors such as radar system performance, target characteristics, or environmental conditions. This adaptability allows for improved accuracy in identifying and filtering false targets under different operating conditions. For instance, the radar system performance may be influenced by factors such as the platform's motion, antenna beamwidth, and radar signal-to-noise ratio (SNR). Target characteristics can include aspects like velocity, size, and radar cross-section (RCS). Environmental conditions may encompass weather factors (rain, snow, fog), terrain (mountains, buildings), or the presence of clutter (birds, chaff). In an embodiment, to enhance the radar system's precision in discerning and eliminating false targets, the tolerance level is adjustable based on the aforementioned factors. For example, when the radar system encounters low SNR or is impacted by the motion of the platform, the tolerance level can be increased to account for the heightened uncertainty in radar measurements. This adjustment helps mitigate the likelihood of false target identification resulting from noisy or inaccurate data. Similarly, for fast-moving targets, the Doppler frequency shift and change in range can be more pronounced than for slow-moving targets. In such cases, the tolerance level can be modified according to the target's velocity or other characteristics, accommodating the expected variations in the Doppler frequency shift and change in range. In an embodiment, during adverse weather conditions like heavy rain or snow, the radar signal may be subject to attenuation or increased clutter, which can affect the accuracy of radar measurements. To address this issue, the tolerance level can be raised to account for the escalated uncertainty, preventing the false identification of clutter or noise as valid targets.

A range threshold is determined 414 based on the Doppler frequency shift, the time period between the first and second radar scan frames, and the range difference between the initial point and the matching point. The range threshold is a value that helps distinguish valid targets from false targets based on their motion characteristics. The calculation may involve mathematical models or algorithms that consider target dynamics, radar system characteristics, and environmental factors.

A determination 416 is made whether the point is a valid target based on the determined range threshold. In an embodiment, the validity of the point can be evaluated by comparing the calculated range threshold with a predetermined validation threshold. If the range threshold is below the validation threshold, the point is considered a valid. Otherwise, the point is classified as a false target. In accordance with various embodiments, the process can be repeated for multiple points and scan frames to accurately identify and filter false targets in radar systems, thereby enhancing the overall performance and reliability of the system.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

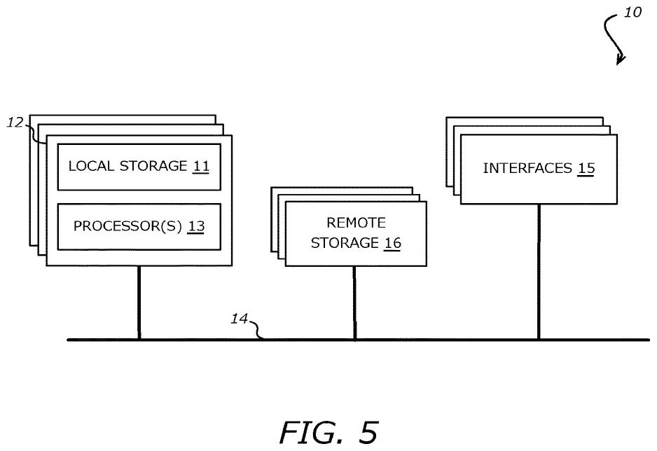

Referring now to FIG. 5, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 5 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a JAVA virtual machine or equivalent, or files containing higher level code that may be executed by the computer using an interpreter (for example, scripts written in Python, Perl, Ruby, Groovy, or any other scripting language).

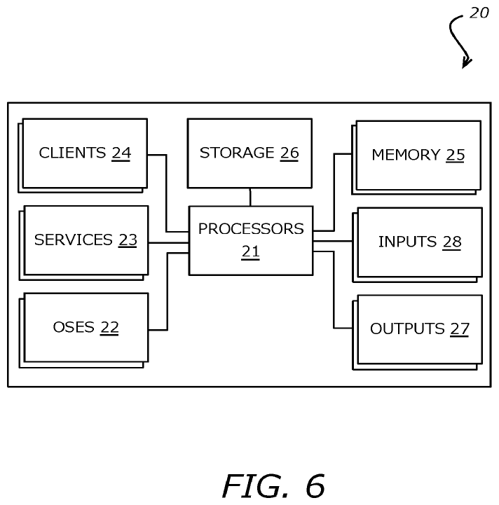

In some embodiments, systems may be implemented on a standalone computing system. Referring now to FIG. 6, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

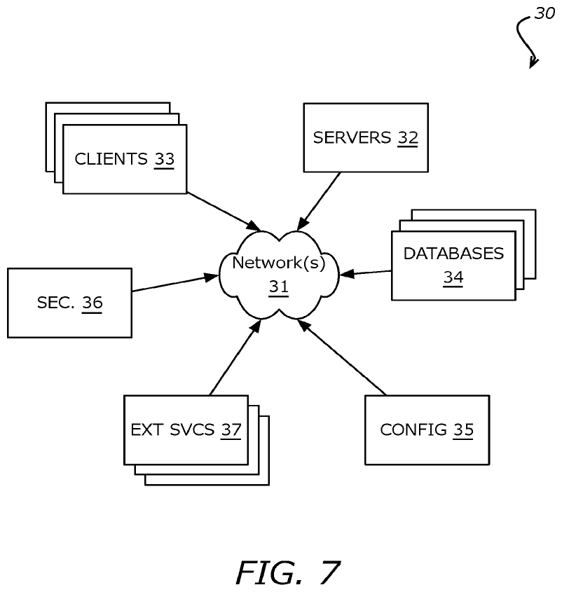

In some embodiments, systems may be implemented on a distributed computing network, such as one having any number of clients and/or servers. Referring now to FIG. 7, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

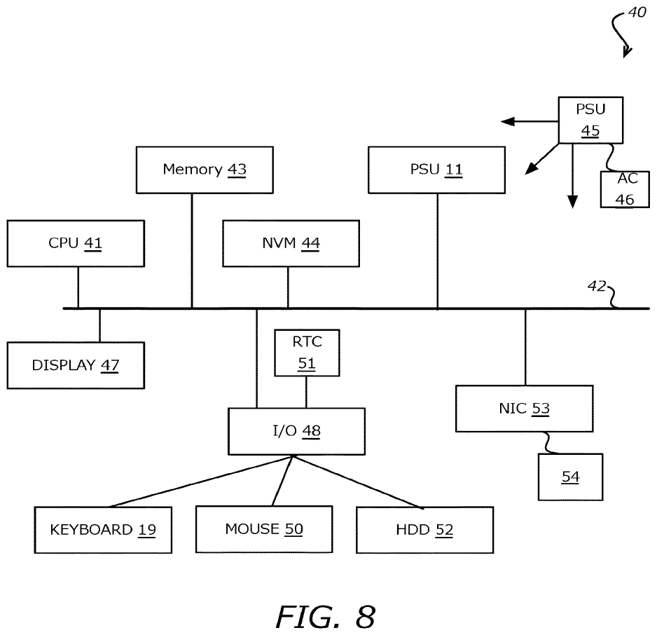

FIG. 8 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

1. A radar system for identifying and filtering false targets represented in radar data, comprising:
a radar transmitter configured to emit radar signals;
a radar receiver configured to collect reflected radar signals from objects within an environment;
a processor; and
a memory device including instructions that, when executed by the processor, cause the radar system to:
obtain a first radar scan comprising a plurality of points;
select a point from the first radar scan, the selected point having a previous range and an associated Doppler;
validate the selected point by determining whether a difference between a measured range change of the selected point between the first radar scan and a subsequent radar scan, and a Doppler-based range change associated with the selected point satisfies a validation threshold;
obtain a second radar scan;
determine an expected range of the validated selected point in the second radar scan by calculating a sum of the previous range of the selected point and a product of the Doppler associated with the selected point and the time duration between the first and second scan frames, wherein the expected range indicates a predicted location of the validated selected point in the second radar scan;
identify a search area within the second radar scan comprising a three-dimensional volume around the expected range such that a Euclidean distance relative to a point located at the expected range does not exceed a predefined threshold;
identify a matching point within the search area in the second radar scan; and
determine whether the matching point corresponds to the validated selected point based on at least one criterion selected from a range threshold, a Doppler frequency shift, or positional validation.

2. The radar system of claim 1, wherein validating the selected point comprises calculating a difference value ε according to:
$$ε = \vert d * {t}_{scan} - {r}_{current} + {r}_{previous} \vert$$
where:
d is the Doppler value associated with the selected point,
rₚᵣₑᵥᵢₒᵤₛ is the range of the selected point in the first radar scan,
r_{current} is the range of the selected point in the subsequent radar scan,
t_{scan} is the time duration between the first radar scan and the subsequent radar scan, and
wherein the difference value ε is compared with the validation threshold to validate the selected point.

3. The radar system of claim 1, wherein the expected range is determined according to:
$${r}_{expected} = {r}_{previous} + d * {t}_{scan}$$
where:
r_{expected} is the expected range of the selected point in the second radar scan;
rₚᵣₑᵥᵢₒᵤₛ is the radar-reported range of the selected point in the first radar scan;
d is the Doppler value associated with the selected point; and
t_{scan} is the time duration between the first radar scan and the second radar scan.

4. The radar system of claim 1, wherein positional validation of the matching point comprises determining a Euclidean distance between the validated selected point and the matching point according to:
$$distance = \sqrt{{( {x}_{2} - {x}_{1} )}^{2} + {( {y}_{2} - {y}_{1} )}^{2} + {( {z}_{2} - {z}_{1} )}^{2}}$$
where
x₁, y₁, z₁ are coordinates of the validated selected point from the first radar scan, and
x₂, y₂, z₂ are coordinates of the matching point identified in the second radar scan.

5. The radar system of claim 4, wherein the matching point is determined to correspond to the validated selected point when the calculated Euclidean distance is less than or equal to a pre-determined positional threshold.

6. The radar system of claim 1, wherein identifying the matching point further comprises comparing Doppler values associated with candidate points in the search area with the Doppler associated with the validated selected point.

7. The radar system of claim 1, wherein determining whether the matching point corresponds to the validated selected point comprises calculating:
$$ε = \vert d * {t}_{scan} - {r}_{found} + {r}_{previous} \vert$$
where:
ε is a range threshold used to determine whether the matching point corresponds to the validated selected point;
d is the Doppler of the validated selected point;
t_{scan} is a time duration between the first radar scan and the second radar scan;
rₚᵣₑᵥᵢₒᵤₛ is the radar-reported range of the validated selected point in the first radar scan; and
r_{found} is the radar-reported range of the matching point in the second radar scan.

8. The radar system of claim 1, wherein selecting the point from the first radar scan comprises selecting the point based on at least one of a predefined azimuth, range, elevation, Doppler value, or a predefined ordering of points.

9. The radar system of claim 1, wherein the point is randomly selected from the first radar scan.

10. The radar system of claim 1, wherein determining the expected range further comprises updating the expected range based on identified factors that impact precision of range measurements obtained, wherein the identified factors include environmental conditions, hardware limitations, or measurement errors, and wherein the search area in the second radar scan is identified based on the updated expected range.

11. The radar system of claim 1, wherein determining whether the matching point corresponds to the validated selected point further comprises validating positional similarity between the validated selected point and the matching point.

12. The radar system of claim 1, wherein identifying and filtering false targets occurs prior to initiation of a target tracking process.

13. A method for identifying and filtering false targets in radar data, comprising:
obtaining a first radar scan comprising a plurality of points;
selecting a point from the first radar scan, the selected point having a previous range and an associated Doppler;
validating the selected point by determining whether a difference between a measured range change of the selected point between the first radar scan and a subsequent radar scan, and a Doppler-based range change associated with the selected point satisfies a validation threshold;
obtaining a second radar scan;
determining an expected range of the validated selected point in the second radar scan by calculating a sum of the previous range of the selected point and a product of the Doppler associated with the selected point and the time duration between the first and second scan frames;
identifying a search area within the second radar scan comprising a three-dimensional volume around the expected range such that a Euclidean distance to an expected point does not exceed a predefined threshold;
identifying a matching point within the search area in the second radar scan; and
determining whether the matching point corresponds to the validated selected point.

14. The method of claim 13, wherein validating the selected point comprises calculating a difference value ε according to:
$$ε = \vert d * {t}_{scan} - {r}_{current} + {r}_{previous} \vert$$
where:
d is the Doppler value associated with the selected point,
rₚᵣₑᵥᵢₒᵤₛ is the range of the selected point in the first radar scan,
r_{current} is the range of the selected point in the subsequent radar scan,
t_{scan} is the time duration between the first radar scan and the subsequent radar scan, and
wherein the difference value ε is compared with the validation threshold to validate the selected point.

15. The method of claim 13, wherein the expected range is determined according to:
$${r}_{expected} = {r}_{previous} + d * {t}_{scan}$$
where:
r_{expected} is the expected range of the selected point in the second radar scan;
rₚᵣₑᵥᵢₒᵤₛ is the radar-reported range of the selected point in the first radar scan;
d is the Doppler of the selected point, representing the radial velocity of the point relative to the radar; and
t_{scan} is the time duration between the first radar scan and the second radar scan.

16. The method of claim 13, wherein positional validation of the matching point comprises determining a Euclidean distance between the validated selected point and the matching point according to:
$$distance = \sqrt{{( {x}_{2} - {x}_{1} )}^{2} + {( {y}_{2} - {y}_{1} )}^{2} + {( {z}_{2} - {z}_{1} )}^{2}}$$
where
x₁, y₁, z₁ are coordinates of the validated selected point from the first radar scan, and
x₂, y₂, z₂ are coordinates of the matching point identified in the second radar scan.

17. The method of claim 13, further comprising validating similarity between the validated selected point and the matching point by comparing both a Doppler associated with the validated selected point and a positional distance between the validated selected point and the matching point.

18. A radar system for validating radar targets represented in radar data, comprising:
a processor; and
a memory storing instructions that, when executed by the processor, cause the radar system to:
obtain a plurality of radar scan frames including a first radar scan frame and N subsequent radar scan frames, each scan frame including a plurality of radar points;
select a point from the first radar scan frame, the selected point having a range from the radar and an associated Doppler;
determine an expected range of the selected point in each of the N subsequent radar scan frames based on a sum of the range of the selected point in the first radar scan frame and a product of the Doppler associated with the selected point and a time duration between scan frames;
for each of the N subsequent radar scan frames, identify a search area within the radar scan frame centered around the expected range;
identify candidate matching points within the search area in each of the N subsequent radar scan frames;
validate candidate matching points by determining whether a difference between
a measured change in range of the candidate matching point relative to the selected point and an expected range change determined from the Doppler associated with the selected point and the time duration between scan frames is below a validation threshold;
increment a positive identification count (c) when a candidate matching point satisfies the validation threshold; and
determine that the selected point represents a valid radar target when the positive identification count (c) is greater than or equal to a predetermined threshold (M).

19. The radar system of claim 18, wherein validating candidate matching points further comprises determining a positional distance between the selected point and each candidate matching point, wherein the positional distance is calculated as a square root of a sum of squared differences between corresponding x-coordinates, y-coordinates, and z-coordinates of the selected point and the candidate matching point.

20. The radar system of claim 18, wherein the candidate matching point identified within a corresponding search area is counted toward the positive identification count (c) when the positional distance between the selected point and the candidate matching point is less than or equal to a predetermined positional threshold.
